(19) United States
(12) Patent Application Publication
(10) Pub. No.: US 2012/0146899 A1
(43) Pub. Date: Jun. 14, 2012

(54) WEARABLE POINTING DEVICE

(75) Inventor: JYUN-YI TENG, Tu-Cheng (TW)

(73) Assignee: CHI MEI COMMUNICATION SYSTEMS, INC., Tu-Cheng (TW)

(21) Appl. No.: 13/151,263

(22) Filed: Jun. 1, 2011

(30) Foreign Application Priority Data
Dec. 14, 2010 (TW) 99143707

(51) Int. Cl. G06F 3/041; G06F 3/033

(52) U.S. Cl. 345/157

(57) ABSTRACT

A wearable pointing device can be worn on a hand of a user and includes a hand strap, a receiving part, a first ring, a second ring, a third ring and a circuit module. The circuit module is electronically connected to the first ring, the second ring, and the third ring. The circuit module is installed in the receiving part and comprises a sensor module to sense movement on the hand. The sensor module converts the movement of the wearable pointing device into signals which are sent to a host computing device. The data received from the pointing device may be used to move a cursor of the computing device, or correspond to left and right mouse clicks, and scrolling operations.

### BACKGROUND

1. Technical Field

Embodiments of the present disclosure relate to a pointing device used in electronic device, and more particularly to a wearable pointing device used in conjunction with a personal computer.

2. Description of Related Art

Computer mice, as input devices, can sometimes be inconvenient when there is a shortage of desk space or other suitable flat surface. What is needed, therefore, is another input which can be worn on user's hand to overcome the limitations described.

### BRIEF DESCRIPTION OF THE DRAWINGS

FIG. 1 is a schematic diagram of one embodiment of a wearable pointing device worn on a hand.

FIG. 2 is another schematic diagram of one embodiment of the wearable pointing device of FIG. 1.

FIG. 3 is a schematic diagram of one embodiment of the wearable pointing device in operation.

FIG. 4 is another schematic diagram of one embodiment of the wearable pointing device in operation.

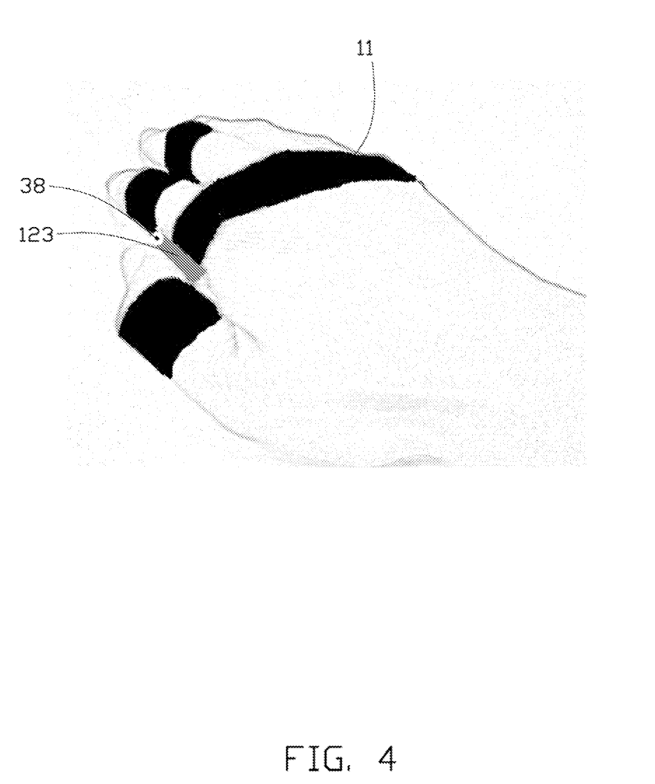

FIG. 5 is another schematic diagram of one embodiment of the wearable pointing device in operation.

FIG. 6 is another schematic diagram of one embodiment of the wearable pointing device in operation.

FIG. 7 is another schematic diagram of one embodiment of the wearable pointing device in operation.

FIG. 8 is another schematic diagram of one embodiment of the wearable pointing device in operation.

FIG. 9 is a block diagram of one embodiment of the wearable pointing device of FIG. 1 in wireless connection with a computer host.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or Assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

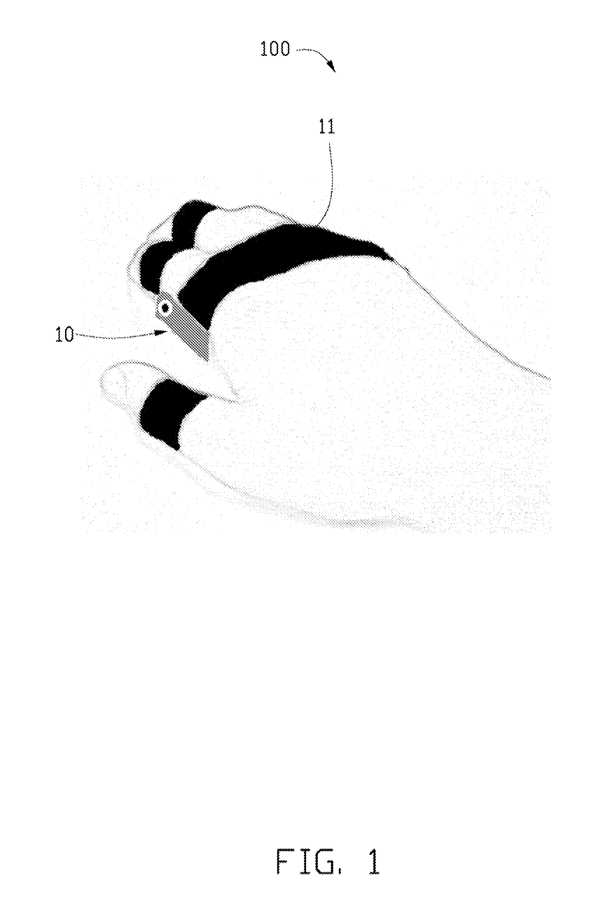

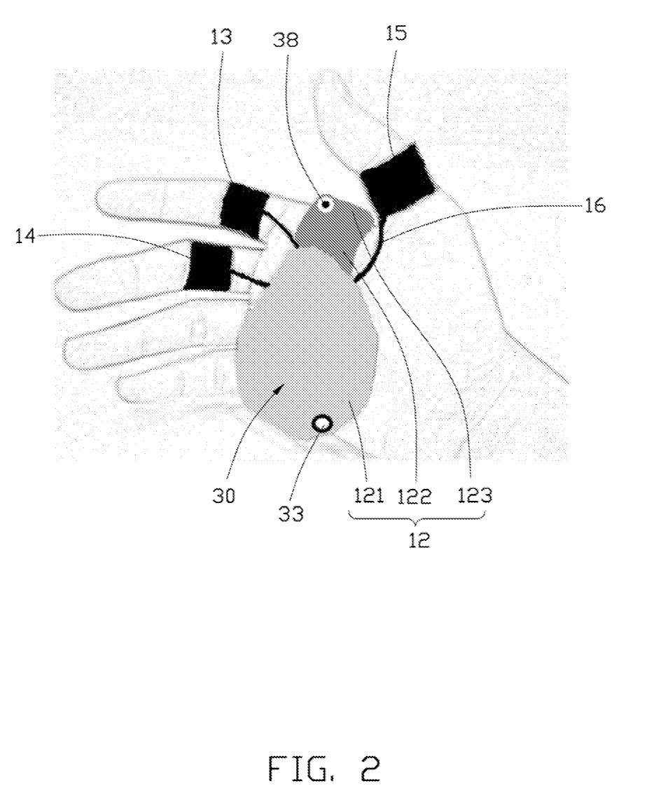

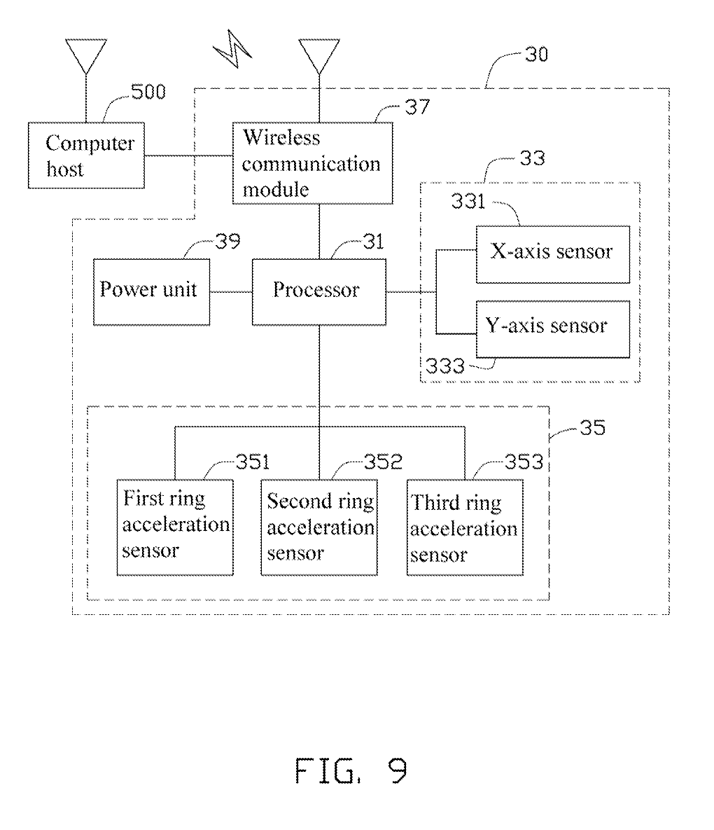

FIG. 1 and FIG. 2 are schematic diagrams of one embodiment of a wearable pointing device 100. FIG. 9 is a block diagram of one embodiment of the wearable pointing device 100 in wireless connection with a computer host 500. In the following embodiments, the device 100 is configured to be worn on a hand, but other configurations are possible, particularly for the disabled. The wearable pointing device 100 includes a body 10 and a circuit module 30. A user can wear the body 10 on one hand. The user can move fingers of the hand to generate commands As shown in FIG. 9, the circuit module 30 wirelessly communicates with the computer host 500 to input data or control signals such as those generated by a general computer mouse. In addition, the user is not limited to only using the device 100, but can also use other input devices, such as a keyboard, at the same time when using the device 100.

The body 10 includes a hand strap 11, a receiving part 12, a first ring 13, a second ring 14, and a third ring 15, which together can be worn on a hand of a user. The receiving part 12 is removably installed in the hand strap 11 and receives the circuit module 30. Connection wires 16 electronically connect the first ring 13, the second ring 14, and the third ring 15 to the circuit module 30.

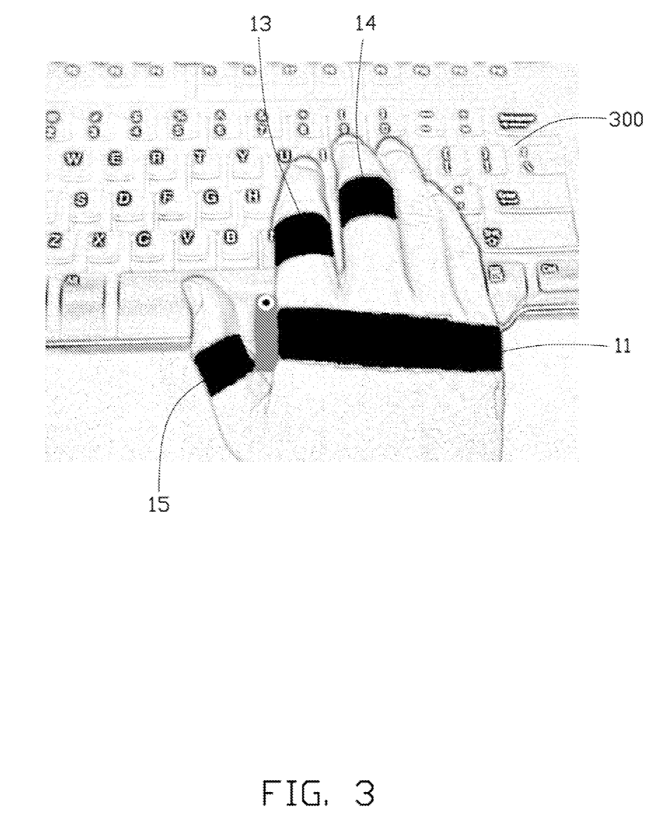

Referring also to FIG. 3, the hand strap 11 is made of an elastic material for comfortably holding the device 100 on the hand, and thus can accommodate different sized hands. As shown in FIG. 2, the receiving part 12 includes a receiving space 121 and a connection board 122 connected to the receiving space 121. The connection board 122 includes touch panel 123 and is electronically connected to the circuit module 30. The user can move at least one finger on the touch panel 123 to execute a scrolling function, similar to an action using a scroll wheel of a general computer mouse. In one embodiment, the user can move his/her thumb on the touch panel 123 to execute the scrolling function.

The first ring 13, the second ring 14, and the third ring 15 may also be made of elastic material to accommodate different sized hands. In one embodiment, the first ring 13 can be worn on the index finger, the second ring 14 can be worn on the middle finger and the third ring 15 can be worn on the thumb.

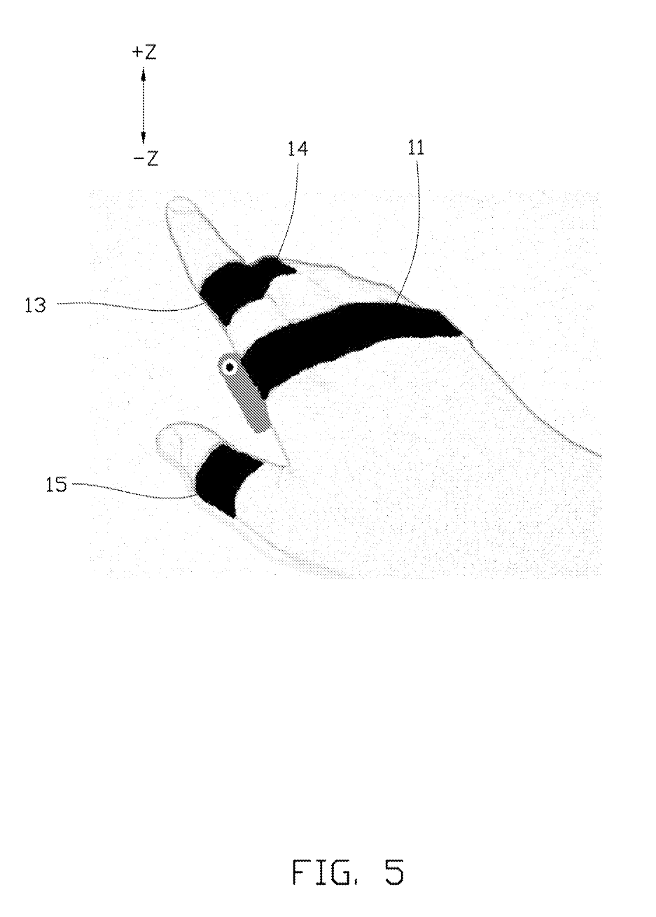

As shown in FIG. 5, the user can raise the first ring 13 along the +Z direction to execute a left click function of the wearable pointing device 100. When the user lowers the first ring 13 along the −Z direction the left click function is ceased.

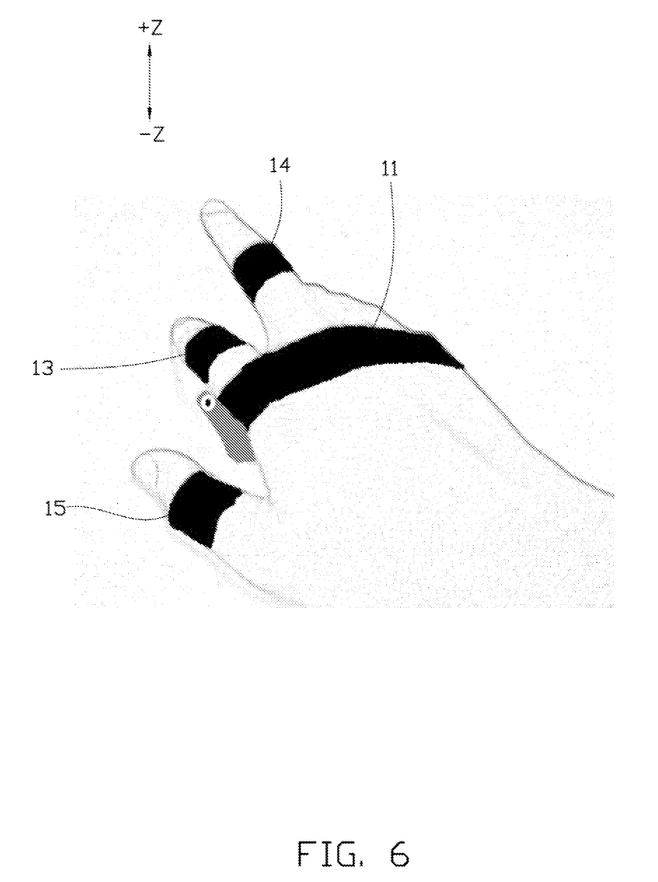

As shown in FIG. 6, the user can raise the second ring 14 to execute a right click function, and lower the second ring 14 to cease the right click function.

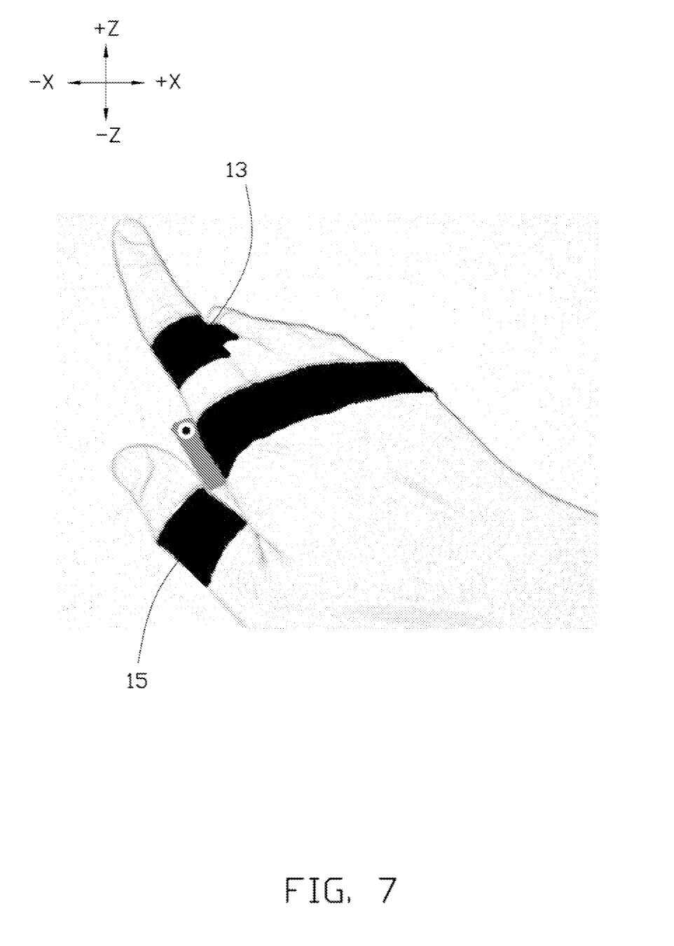

As shown in FIG. 7, the user can raise the first ring 13 along the +Z direction and move the thumb with the third ring 15 close to the first ring 13 to execute a zoom-out function to adjust view of what is currently displayed by the host computer host 500.

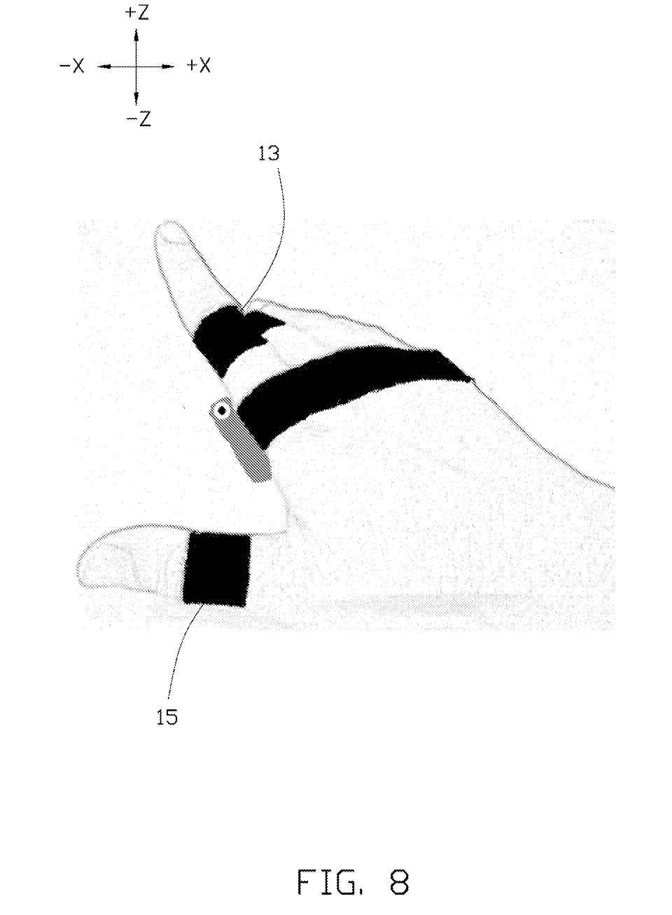

As shown in FIG. 8, the user can raise the first ring 13 along the +Z direction and move the third ring 15 away from the first ring 13 to execute a zoom-in function to adjust view of what is currently displayed by the host computer host 500.

FIG. 9 is a block diagram of one embodiment of the wearable pointing device 100 in wireless connection with the computer host 500. The circuit module 30 enables the wearable pointing device 100 to wirelessly communicate with the computer host 500. The circuit module 30 includes at least one processor 31, a position sensor module 33, an operation module 35, a wireless communication module 37, and a power unit 39. The at least one processor 31 is electronically connected to the position sensor module 33, the operation module 35, the wireless communication module 37, and the power unit 39.

The at least one processor 31 transforms signals received from the position sensor module 33 and the operation module 35 into control signals. The wireless communication module 37 then transmits the control signals to the computer host 500. The computer host 500 executes corresponding operations according the control signals. The at least one processor 31, as an example, may include a CPU, a math coprocessor, and/or a shift register, for example.

As shown in FIG. 2, the position sensor module 33 is installed in the receiving part 12 and positioned in the side away from the touch panel 123. The position sensor module 33 is operable to detect the movements of the wearable pointing device 100. The position sensor module 33 includes a X-axis sensor 331 and a Y-axis sensor 333. The X-axis sensor 331 is operable to detect the movement of the wearable pointing device 100 along the X-axis. The Y-axis sensor 333 is operable to detect the movement of the wearable pointing device 100 along the Y-axis. In one embodiment, the X-axis sensor 331 and the Y-axis sensor 333 are both optical position sensors.

The operation module 35 is operable to execute operations corresponding to left and right mouse clicks, and scrolling operations. The operation module 35 includes a first ring acceleration sensor 351, a second ring acceleration sensor 352, and a third ring acceleration sensor 353. The ring acceleration sensors 351, 352, 353 are operable to detect acceleration of the corresponding rings 13, 14, and 15.

The wireless communication module 37 transmits signals corresponding to the detected acceleration of the first ring 13, the second ring 14, and the third ring 15 to the computer host 500. The signals comprise X-axis, Y-axis, and Z-axis components of the detected accelerations. The computer host 500 can execute corresponding operations according to the signals. In one embodiment, the wireless communication module 37 is a BLUETOOTH communication module.

The power unit 39 is operable to supply electronic power to the circuit module 30. In one embodiment, the power unit 39 may be a rechargeable battery, such as a lithium battery.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A wearable pointing device configured for wearing on a hand of a user, comprising:
a body comprising:
a hand strap;
a first ring configured to execute a left click function according to movement of the first ring;
a second ring configured to execute a right click function according to movement of the second ring;
a third ring used in conjunction with the first ring to execute a zoom-out function or a zoom-in function according to movement of the first ring and the third ring together; and
a receiving part positioned on the hand strap; and
a circuit module positioned in the receiving part, and electronically connected to the first ring, the second ring, and the third ring.

2. The wearable pointing device of claim 1, wherein the hand strap, the first ring, the second ring and the third ring are made of an elastic material.

3. The wearable pointing device of claim 1, wherein the hand strap further comprises a touch panel in electronic connection with the circuit module.

4. The wearable pointing device of claim 3, wherein the touch panel is configured for sensing a finger movement of the hand of the user to execute a scrolling function.

5. The wearable pointing device of claim 1, wherein the circuit module comprises a position sensor module to sense movement of the wearable pointing device.

6. The wearable pointing device of claim 5, wherein the circuit module further comprises:
a first ring acceleration sensor configured for detecting the movement of the first ring;
a second ring acceleration sensor configured for detecting the movement of the second ring; and
a third ring acceleration sensor configured for detecting the movement of the third ring.

7. The wearable pointing device of claim 5, wherein the position senor module includes at least one optical positioning sensor.

8. The wearable pointing device of claim 1, wherein the circuit module further comprises a wireless communication module communicating with a computer host.

9. The wearable pointing device of claim 8, wherein the wireless communication module is BLUETOOTH.

10. The wearable pointing device of claim 1, further comprising at least one processor operable to process signals received from the first ring acceleration sensor, the second ring acceleration sensor, the third ring acceleration sensor and the touch panel.
